(19) United States
(12) Patent Application Publication
(10) Pub. No.: US 2026/0055651 A1
(43) Pub. Date: Feb. 26, 2026

(54) DRIVE ARRANGEMENT FOR ADJUSTING A FLAP OF A MOTOR VEHICLE

(71) Applicant: Brose Fahrzeugteile SE & Co. Kommanditgesellschaft, Bamberg, Bamberg (DE)

(72) Inventors: Leo Kroener, Bischberg (DE); Florian Woelker, Hausen (DE); Julian Simon, Bamberg (DE)

(21) Appl. No.: 18/811,087

(22) Filed: Aug. 21, 2024

(51) Int. Cl. E05F 15/614

(52) U.S. Cl. CPC E05F 15/614; E05Y 2201/43; E05Y 2201/706; E05Y 2900/544

(57) ABSTRACT

A drive arrangement for adjusting a flap of a motor vehicle wherein the flap is mounted to a vehicle body such that the flap is pivotally movable in relation to the vehicle body between an open position and a closed position, wherein the drive arrangement comprises a drive unit for moving the flap between the open position and the closed position, wherein the drive unit comprises an electric drive, a drive unit housing, in which the electric drive is housed, and an output shaft which is rotatable mounted inside the drive unit housing, wherein the output shaft comprises a shaft interface for connecting the output shaft to the vehicle body. It is proposed that the output shaft is rotatably supported inside the drive unit housing only.

### FIELD OF THE TECHNOLOGY

Various embodiments relate to a drive arrangement for adjusting a flap of a motor vehicle and to a flap arrangement of a motor vehicle.

### BACKGROUND

The known prior art (U.S. Pat. No. 11,345,418 B2) that builds the basis of some embodiments is related to a drive arrangement for adjusting a flap of a motor vehicle. This flap is mounted to a vehicle body such that the flap is pivotally movable in relation to the vehicle body between an open position and a closed position.

The drive arrangement further comprises a drive unit with a drive, a drive unit housing, in which the drive is housed, and an output shaft driven by the drive, which output shaft is rotatable mounted inside the drive unit housing. As is generally known in the field of drive arrangements for motor vehicles, this drive can be an electric drive. The drive unit is adapted for moving the flap between the open position and the closed position, and the output shaft comprises a shaft interface for connecting the output shaft to the vehicle body in a non-rotational manner.

### SUMMARY

It is a challenge to provide a support of the output shaft that enables a simple mounting of the drive arrangement to a flap of a motor vehicle.

Various embodiments are based on the problem of improving the known drive arrangement such that a further optimization regarding the named challenge is reached.

The above-noted object is solved by various features described herein.

A flap of a motor vehicle may be a tailgate, a lift gate, a trunk lid, a back door, a front hood, a side door or the like. All those flaps are pivotable about a flap pivot axis and can be adjusted between an open position and a closed position over a pivot angle.

An aspect of various embodiments is that the output shaft is usually rotatably supported on the drive unit as well as on the flap itself. Supporting the output shaft inside the drive unit housing only makes an additional support on the flap unnecessary, so that the drive arrangement can be installed on the flap without any additional installation steps of a second output shaft support on the flap.

In detail, it is proposed that the output shaft is rotatably supported inside the drive unit housing only.

Various embodiments specify the output shaft to be rotatably supported inside the drive unit housing by a single bearing only, which simplifies the assembly of the drive arrangement, as only one bearing needs to be fitted inside the drive unit housing for supporting the output shaft.

Various embodiments specify the bearing to be fully arranged within the flap in a mounted state of the drive arrangement. Such an embodiment further simplifies the mounting of the flap to the vehicle body as the output shaft may be the only element that protrudes from the flap which must be fitted during an installation of the flap.

Various embodiments relate to the direction in which the output shaft is rotatably supported and further specify the preferred type of bearing. The use of a rolling-element bearing such as a ball bearing or a roller bearing provides the advantage of supporting the output with very little friction.

Various embodiments relate to flap arrangement of a motor vehicle comprising a flap and at least one proposed drive arrangement, the proposed drive arrangement being functionally connected to the flap.

All explanations given with regard to the drive arrangement are fully applicable.

Various embodiments provide a drive arrangement for adjusting a flap of a motor vehicle, wherein the flap is mounted to a vehicle body such that the flap is pivotally movable in relation to the vehicle body between an open position and a closed position, wherein the drive arrangement comprises a drive unit for moving the flap between the open position and the closed position, wherein the drive unit comprises an electric drive, a drive unit housing, in which the electric drive is housed, and an output shaft driven by the electric drive, which output shaft is rotatable mounted in the drive unit housing, wherein the output shaft comprises a shaft interface for connecting the output shaft to the vehicle body, wherein the output shaft is rotatably supported inside the drive unit housing only.

In various embodiments, the output shaft is rotatably supported inside the drive unit housing by a single bearing only.

In various embodiments, the bearing is fully arranged within the flap in a mounted condition of the drive arrangement.

In various embodiments, the output shaft is rotatably supported radially to the axis of rotation of the output shaft only, or, that the output shaft is rotatably supported radially and axially to the axis of rotation of the output shaft, and/or, that the bearing is a plain bearing or a rolling-element bearing such as a ball bearing or a roller bearing.

Various embodiments provide a flap arrangement of a motor vehicle comprising a flap and at least one drive arrangement according to the disclosure, the drive arrangement being functionally connected to the flap.

### BRIEF DESCRIPTION OF THE DRAWINGS

In the following, various aspects of some embodiments are explained with respect to the drawing. The drawing shows in

FIG. 1 a) a motor vehicle with a proposed flap arrangement comprising a proposed drive arrangement and b) an enlarged view of the proposed flap arrangement and

FIG. 2 a) a flap with a proposed drive arrangement comprising an electric drive on the right-hand side of the flap and with a motorless drive arrangement on the left-hand side of the flap, and b)-e) enlarged views of different types of connections between a shaft interface of an output shaft of the proposed drive arrangement and a flap mount assembly.

### DETAILED DESCRIPTION

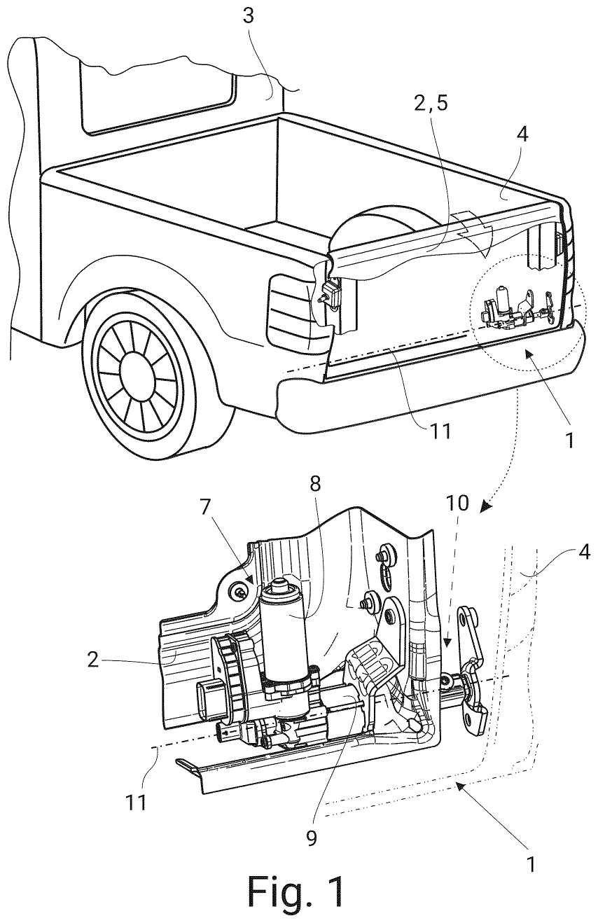

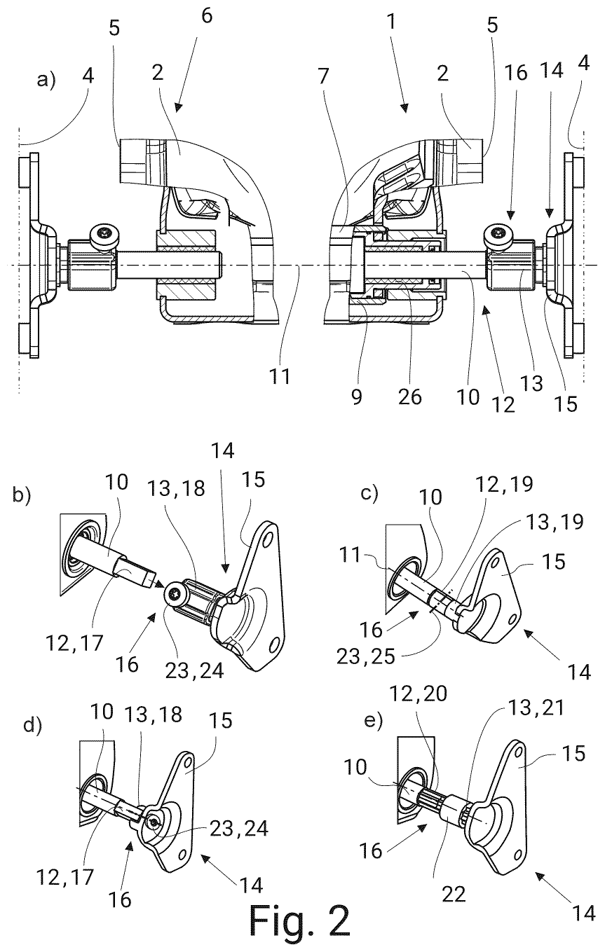

Various embodiments, which is shown in the FIGS. 1 and 2, relate to a drive arrangement 1 for adjusting a flap 2 of a motor vehicle 3. As illustrated in FIG. 1, the flap 2 is mounted to a vehicle body 4 such that the flap 2 is pivotally movable in relation to the vehicle body 4 between an open position and a closed position. The flap 2 comprises an outer side 5 which faces away from the flap 2. In some embodiments, the flap 2 is a pickup truck tailgate. However, the expression “flap” is to be understood in a broad sense. It includes in particular any kind of pivotable doors of a motor vehicle 3, such as tailgates, lift gates, trunk lids, back doors, front hoods, side doors, or the like.

The flap 2 of the motor vehicle 3 may, as shown in FIG. 1, have exactly one drive arrangement 1 for adjusting the flap 2. However, in principle, further drive arrangements 1 may be assigned to the flap 2 of the motor vehicle 3, in particular a further motorless drive arrangement 6. For example, the flap 2 may, as illustrated in FIG. 2a), comprise a proposed drive arrangement 1 and a motorless drive arrangement 6, each drive arrangement 1 being arranged on opposite sides of the flap 2.

The drive arrangement 1 comprises a drive unit 7 for moving the flap 2 between the open position and the closed position. Thus, the drive unit 7 enables automatic closing and/or opening of the flap 2, for example, in reaction of a respective control signal.

The drive unit 7 comprises an electric drive 8, a drive unit housing 9 in which the electric drive 8 is housed, and an output shaft 10 to be connected to the vehicle body 4 in a non-rotational manner. The output shaft 10 is rotatable mounted in the drive unit housing 9 and can rotate, in course of a rotational movement, about an axis of rotation 11, which is, in some embodiments, oriented in horizontal direction (in a mounted condition of the drive arrangement 1, like it is shown in FIG. 1). In various embodiments, the axis of rotation 11 of the output shaft 10 and the pivoting axis of the flap 2 are coaxially arranged. The electric drive 8 may comprise a motor shaft (not shown) for driving the output shaft 10, the axis of rotation of which is, in some embodiments, arranged orthogonally with respect to the axis of rotation 11 of the output shaft 10.

Generally, it is possible that the drive unit 7 comprises further components (which can be partly seen in FIG. 1), like a transmission arrangement, especially reduction gear, a clutch arrangement, or the like. The further components may be housed inside the drive unit housing 9, like it is the case for some embodiments.

In various embodiments, and as shown in FIGS. 1 and 2, the output shaft 10 is partly housed inside the drive unit housing 9 and thereby partially extending from the inside to the outside of the drive unit housing 9. However, in another embodiment (not shown) the output shaft 10 may be arranged fully inside the drive unit housing 9, thereby not extending from the inside to the outside of the drive unit housing 9.

The output shaft 10 comprises a shaft interface 12 for connecting the output shaft 10 to the vehicle body 4 in a non-rotational manner. As illustrated in FIGS. 1 and 2, in the mounted condition of the drive arrangement 1, the shaft interface 12 interacts with a flap mount interface 13 of a flap mount assembly 14. The flap mount assembly 14 comprises a flap mount adapter 15 and the flap mount interface 13, which is fixed on the flap mount adapter 15. The flap mount assembly 14 however is fixed on the vehicle body 4 via the flap mount adapter 15 in the mounted condition of the drive arrangement 1, like it is shown in FIG. 2a). The output shaft 10 and the vehicle body 4 are connected via the flap mount assembly 14 so that a rotation of the output shaft 10 in relation to the vehicle body 4 is prevented.

As illustrated in FIG. 2, the shaft interface 12 and the flap mount interface 13 may be connected to each other by a shaft-connection 16 in a motion-proof manner. The shaft interface 12 may be shaped as a square male adapter 17, and the flap mount interface 13 may be shaped as a corresponding square female adapter 18. In the mounted condition of the drive arrangement 1, the square female adapter 18 may accommodate the square male adapter 17, as illustrated in FIGS. 2b) and 2d) to form the shaft-connection 16. Alternatively, the shaft interface 12 and flap mount interface 13 can each be formed as a pin 19 (FIG. 2c)). These pins 19 can partially overlap each other in the axis of rotation 11 of the output shaft 10 to form a rotation-proof shaft-connection 16 between the shaft interface 12 and flap mount interface 13.

In another embodiment the shaft-connection 16 may comprise a shaft interface 12, which is shaped as a first multi-edged adapter 20, and a flap mount interface 13, which is shaped as a second multi-edged adapter 21 (FIG. 2e)). To form the shaft-connection 16 in the mounted condition of the drive arrangement 1, the first multi-edged adapter 20 and the second multi-edged adapter 21 may comprise an overlapping sleeve 22 which at least partially overlaps the first multi-edged adapter 20 and the second multi-edged adapter 21 as illustrated in FIG. 2e). This overlapping sleeve 22 connects the first multi-edged adapter 20 and the second multi-edged adapter 21 by a material-fit and/or form-fit and/or a force-fit between the overlapping sleeve 22, the first multi-edged adapter 20, and the second multi-edged adapter 21.

The shaft-connection 16 may, alternatively or additionally, comprise a fastening element 23. As illustrated in FIGS. 2b) and 2d), the fastening element may be a fastening screw 24. This fastening screw 24 may be arranged orthogonal (FIG. 2a)) or coaxial (FIG. 2d)) to the axis of rotation 11 of the output shaft 10 in the flap mount interface 13. This fastening screw 24 acts on the shaft interface 12 so that the flap mount interface 13 and the shaft interface 12 cannot move relative to each other. Alternatively, and as shown in FIG. 2c), the fastening element may be formed by a fastening pin 25, which is inserted through overlapping sections of the shaft interface 12 and flap mount interface 13.

The embodiment shown in the figures relates to a drive arrangement for adjusting a flap 2 of a motor vehicle 3, wherein the flap 2 is mounted to a vehicle body 4 such that the flap 2 is pivotally movable in relation to the vehicle body 4 between an open position and a closed position, wherein the drive arrangement 1 comprises a drive unit 7 for moving the flap 2 between the open position and the closed position, wherein the drive unit 7 comprises an electric drive 8, a drive unit housing 9, in which the electric drive 8 is housed, and an output shaft 10 driven by the electric drive 8, which output shaft 10 is rotatable mounted in the drive unit housing 9, wherein the output shaft 10 comprises a shaft interface 12 for connecting the output shaft 10 to the vehicle body 4, characterized in that the output shaft 10 is rotatably supported inside the drive unit housing 9 only.

Essential is that the output shaft 10 is rotatably supported inside the drive unit housing 9 only. The term “rotatably supported” means that the output shaft 10 is in contact to a supporting element, which supports the output shaft 10 and also allows the rotational movement around the axis of rotation 11 of the output shaft 10. “Supported inside the drive unit housing 9 only” means that no supporting element for supporting the output shaft 10 extends from the inside of the drive unit housing 9 to the outside of the drive unit housing 9 or is arranged fully outside of the drive unit housing 9. The output shaft 10 may be rotatably supported at multiple sections of the output shaft 10 inside the drive unit housing 9. In various embodiments, the output shaft 10 is rotatably supported at exactly one section withinside the drive unit housing 9.

As illustrated in FIG. 2a) on the right-hand side of the flap 2, it can be that the output shaft 10 is rotatably supported inside the drive unit housing 9 by a single bearing 26 only. “By a single bearing 26 only” in this context means, that the bearing 26 is the only element that provides a supporting contact to the output shaft 10. As can be seen in FIG. 2a), supporting the output shaft 10 inside the drive unit housing 9 by only one bearing 26 eliminates the need for further support elements of the output shaft 10, such as a hinge-bearing, resulting in cost savings and a simple installation of the drive arrangement 1 in the flap 2.

According to one embodiment it is proposed that the bearing 26 is fully arranged within the flap 2 in the mounted state of the drive arrangement 1. This means that the bearing 26 does not protrude beyond the outer side 5 of the flap 2. In various embodiments, the output shaft 10 is the only element of the drive arrangement 1, that protrudes beyond the outer side 5 of the flap 2.

The arrangement of the bearing 26 was discussed in detail above. In the following, the direction in which the output shaft 10 is rotatably supported and specific types of the bearing 26 will be discussed. According to one embodiment it is proposed that the output shaft 10 is rotatably supported radially to the axis of rotation 11 of the output shaft 10 only. In various embodiments, the output shaft 10 is rotatably supported radially and axially to the axis of rotation 11 of the output shaft 10.

The bearing 26 can be a plain bearing 26. In various embodiments, the bearing 26 is a rolling-element bearing 26, such as a ball bearing 26 or a roller bearing 26. Rolling-element bearings 26 have, due to rolling contact surfaces, a significantly lower friction compared to plain bearings 26, which leads to a higher efficiency and reduced energy loss.

According to another teaching a flap 2 arrangement of a motor vehicle 3 is provided, comprising a flap 2 and at least one proposed drive arrangement 1, the proposed drive arrangement 1 being functionally connected to the flap 2.

All explanations given with regard to the drive arrangement 1 are fully applicable.

1. A drive arrangement for adjusting a flap of a motor vehicle, wherein the flap is mounted to a vehicle body such that the flap is pivotally movable in relation to the vehicle body between an open position and a closed position, wherein the drive arrangement comprises a drive unit for moving the flap between the open position and the closed position, wherein the drive unit comprises an electric drive, a drive unit housing, in which the electric drive is housed, and an output shaft driven by the electric drive, which output shaft is rotatably mounted in the drive unit housing, wherein the output shaft comprises a shaft interface for connecting the output shaft to the vehicle body, wherein the output shaft is rotatably supported inside the drive unit housing only.

2. The drive arrangement according to claim 1, wherein the output shaft is rotatably supported inside the drive unit housing by a single bearing only.

3. The drive arrangement according to claim 2, wherein the bearing is fully arranged within the flap in a mounted condition of the drive arrangement.

4. The drive arrangement according to claim 2, wherein the output shaft is rotatably supported radially to the axis of rotation of the output shaft only.

5. A flap arrangement of a motor vehicle comprising a flap and at least one drive arrangement according to claim 1, the drive arrangement being functionally connected to the flap.

6. The drive arrangement according to claim 2, wherein the output shaft is rotatably supported radially and axially to the axis of rotation of the output shaft.

7. The drive arrangement according to claim 2, wherein the bearing is a plain bearing or a rolling-element bearing such as a ball bearing or a roller bearing.

8. The drive arrangement according to claim 2, wherein the output shaft is rotatably supported radially and axially to the axis of rotation of the output shaft and wherein the bearing is a plain bearing or a rolling-element bearing such as a ball bearing or a roller bearing.
